(19) United States
(12) Patent Application Publication
(10) Pub. No.: US 2015/0273418 A1
(43) Pub. Date: Oct. 1, 2015

(54) SPLASH GUARD ASSEMBLY AND MOUNTING BRACKET

(71) Applicant: Vita-Mix Corporation, Olmsted Township, OH (US)

(72) Inventor: Stephen Patrick Rukavina, Rocky River, OH (US)

(21) Appl. No.: 14/670,018

(22) Filed: Mar. 26, 2015

Related U.S. Application Data
(60) Provisional application No. 61/970,514, filed on Mar. 26, 2014.

(51) Int. Cl. B01F 15/00; F16M 13/02; B01F 7/16; F16B 2/22

(52) U.S. Cl. CPC B01F 15/00967; F16B 2/22; F16M 13/022; B01F 7/16

(57) ABSTRACT

A splash guard assembly for a blending apparatus includes a splash guard mount that is attachable to the blending apparatus and a splash guard body that is removably attachable to the splash guard mount such that the splash guard body can be removably attached to the splash guard mount without the use of tools. In particular, the splash guard body can be removed from and attached to the splash guard mount directly by hand—by a user's hand or hands with no intervention of tools.

### CROSS-REFERENCE TO RELATED APPLICATION

This application claims the benefit of U.S. Provisional Application No. 61/970,514, filed Mar. 26, 2014, which is incorporated in its entirety herein by reference.

### FIELD

The present disclosure relates generally to a splash guard assembly and mounting bracket, and more particularly, to a splash guard assembly and mounting bracket for a spindle mixer.

### BACKGROUND

Spindle mixers typically include an electric motor mounted within a housing. An elongated spindle can be mechanically attached to the motor and can extend downwardly from the motor through the motor housing. An agitator can be coupled to the end of the spindle extending out of the motor housing. A container can be placed below the housing around the agitator and the electric motor can be operable to rotate the spindle/agitator in order to mix contents within a container.

Spindle mixers often generate splash of foodstuff or the media they are mixing, most often due to the centrifugal force generated by the spinning agitator. It is therefore desirable to provide a means of shielding the operator and the adjacent equipment and surfaces from this splash. It is also desirable to make the means of splash protection easy to remove for cleaning while still providing a secure attachment of the splash guarding device to the machine. Designs of the past requiring tools to remove the splash guard are not conducive to regular cleaning, and more often than not, a regular cleaning regime is not maintained due to the extra time required to un-fasten these types of splash protectors or splash guards.

### SUMMARY

The following presents a simplified summary of the disclosure in order to provide a basic understanding of some example aspects described in the detailed description.

In a first aspect, a splash guard assembly for a blending apparatus comprises a splash guard mount that is attachable to the blending apparatus and a splash guard body that is removably attachable to the splash guard mount.

In one example of the first aspect, the splash guard body is slidably connectible with the splash guard mount to removably attach the splash guard body to the splash guard mount. In one example, the splash guard mount comprises a support surface and the splash guard body comprises a coupling surface that slides over the support surface to slidably couple the splash guard body to the splash guard mount. In another example, the splash guard body is slidably connectible to the splash guard mount by sliding at least one guide portion through at least one channel. In yet another example, the splash guard body comprises the at least one guide portion and the at least one channel is defined by the splash guard mount and the blending apparatus when the splash guard mount is attached to the blending apparatus. In still yet another example, the splash guard assembly further comprises a cutout portion and an insert portion that slidably engages within the cutout portion when the splash guard body is slidably coupled to the splash guard mount. In another example, the splash guard body comprises the cutout portion and the splash guard mount comprises the insert portion. In yet another example, the cutout portion comprises a first mating surface and the insert portion comprises a second mating surface. The first mating surface mates with the second mating surface when the splash guard body is slidably coupled to the splash guard mount. In still yet another example, the first mating surface and the second mating surface are both substantially U-shaped. In another example, the splash guard assembly further comprises at least one recess and at least one locking projection, wherein the at least one locking projection engages within the at least one recess when the splash guard body is slidably coupled to the splash guard mount.

In another example of the first aspect, the splash guard body is removably attachable to the splash guard mount by inserting an insert member through a corresponding aperture, wherein the splash guard body comprises one of the insert member and the corresponding aperture and the splash guard mount comprises the other of the insert member and the corresponding aperture. In one example, the insert member comprises an end portion which latches to the aperture to secure the splash guard body to the splash guard mount and requires the splash guard to be lifted for the aperture to disengage the insert member. In another example, the insert member comprises a flexible latching member that is elastically deformable between an expanded state and a compressed state.

In yet another example of the first aspect, the splash guard body comprises a first side wall and a second side wall that are substantially parallel and each comprise an upper portion and a lower portion. The upper portion of the first side wall and the upper portion of the second side wall are spaced a first distance from each other, further wherein the lower portion of the first side wall and the lower portion of the second side wall are spaced a second distance from each other that is different from the first distance.

In still yet another example of the first aspect, the splash guard assembly further comprises a splash shield coupled to the splash guard body such that the splash shield is movable between an open and closed position.

The first aspect may be provided alone or in combination with any one or more of the examples of the first aspect discussed above.

In a second aspect, a mounting bracket for mounting a blending apparatus to a rail having an upper rail member and a lower rail member that is spaced from the upper rail member comprises a main body portion that is attachable to the blending apparatus. The mounting bracket further comprises an upper latching portion extending from the main body portion and a lower latching portion extending from the main body portion. The mounting bracket is removably mountable to the rail by latching the upper latching portion to the upper rail member at a first position and rotating the main body portion about an axis of the upper rail member to a second position wherein the lower rail member is received within the lower latching portion.

In one example of the second aspect, the lower latching portion comprises a curved surface that engages the lower rail member as the main body portion is rotated between the first and second positions and inhibits movement of the lower rail member.

In another example of the second aspect, the lower latching portion comprises a lever member that inhibits movement of the lower rail member as the main body portion is rotated between the first and second positions. In one example, the lever member comprises a first lever portion that extends from the main body portion in a direction toward the upper latching portion and a second lever portion that extends from the first lever portion in a direction away from the upper latching portion. In another example, the lever member is elastically deformable to increase a distance between the lever member and the upper latching portion.

The second aspect may be provided alone or in combination with any one or more of the examples of the second aspect discussed above.

### BRIEF DESCRIPTION OF THE DRAWINGS

These and other features, aspects and advantages of the present disclosure are better understood when the following detailed description is read with reference to the accompanying drawings, in which:

FIG. 1 is a perspective view of an exemplary blending assembly;

FIG. 2 is a side view of the exemplary blending assembly;

FIG. 3 is a perspective view of a mounting bracket for the exemplary blending assembly according to a first embodiment;

FIG. 4 is a partial side view of a blending apparatus of the exemplary blending assembly mounted in a first position with the mounting bracket shown in FIG. 3;

FIG. 5 is a partial side view of the blending apparatus mounted in a second position with the mounting bracket shown in FIG. 3;

FIG. 6 is a perspective view of the mounting bracket according to a second embodiment;

FIG. 7 is a partial side view of the blending apparatus mounted in a first position with the mounting bracket shown in FIG. 6;

FIG. 8 is a partial side view of the blending apparatus mounted in a second position with the mounting bracket shown in FIG. 6;

FIG. 9 is a cross-sectional view of the exemplary blending assembly taken along line 9-9 in FIG. 2;

FIG. 10 is a partial side view of the exemplary blending assembly with a splash shield of the exemplary blending assembly in a first position;

FIG. 11 is a side view of the exemplary blending assembly with the splash shield in a second position;

FIG. 12 is a magnified view of portion 12 in FIG. 9 showing a slidable coupling between a splash guard body and a splash guard mount of the exemplary blending assembly;

FIG. 13 is a side perspective view of the exemplary blending assembly showing a removable coupling between the splash guard body and the splash guard mount using insert portions and apertures according to a first embodiment;

FIG. 14 is a cross-sectional view of the exemplary blending assembly taken along line 14-14 in FIG. 13;

FIG. 15 is a magnified view of portion 15 in FIG. 14;

FIG. 16 is a cross-sectional view of a removable coupling between the splash guard body and the splash guard mount using insert portions and apertures according to a second embodiment; and

FIG. 17 is a cross-sectional view of a removable coupling between the splash guard body and the splash guard mount using insert portions and apertures according to a third embodiment.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, this disclosure may be embodied in many different forms and should not be construed as limited to the embodiments set forth herein.

It is to be noted that the phrases “substantially parallel” and “substantially perpendicular” as used herein when describing the relative orientation of two or more features respectively mean that the features are within 10 degrees or less of parallel and perpendicular, and more preferably, within 5 degrees or less of parallel and perpendicular.

It is to be noted that the phrase “substantially vertical” when describing a feature means that the feature is within 10 degrees or less of vertical, and more preferably, within 5 degrees or less of vertical. Likewise, the phrase “substantially horizontal” when describing a feature means that the feature is within 10 degrees or less of horizontal, and more preferably, within 5 degrees or less of horizontal.

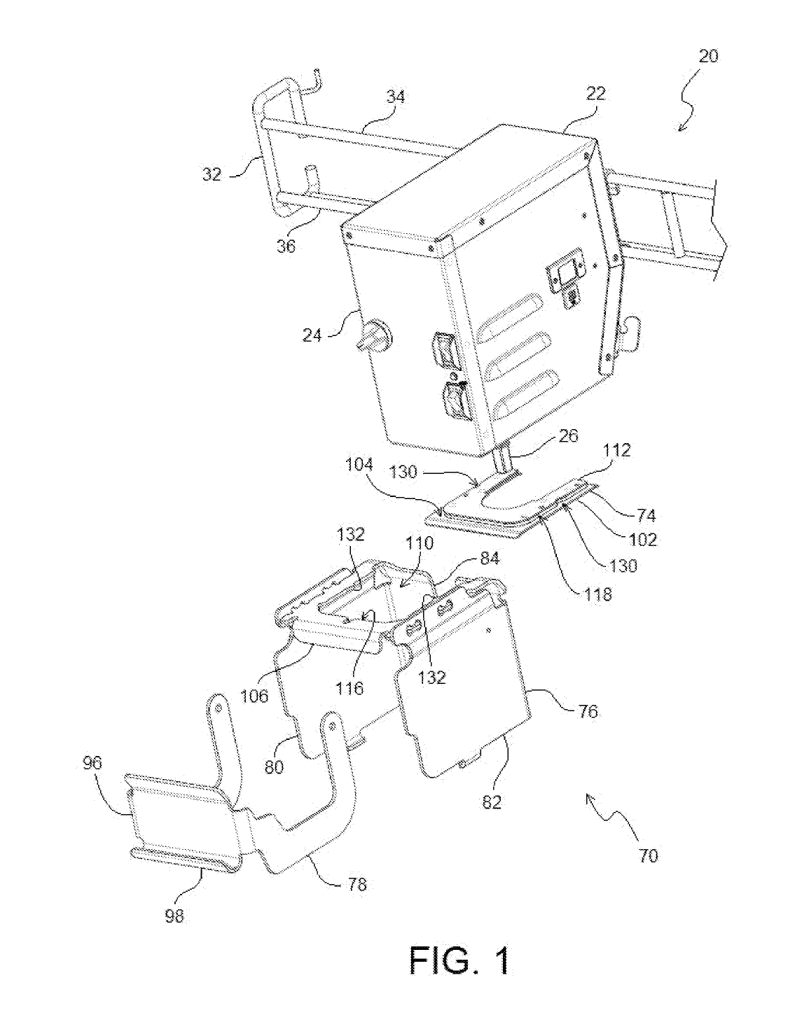

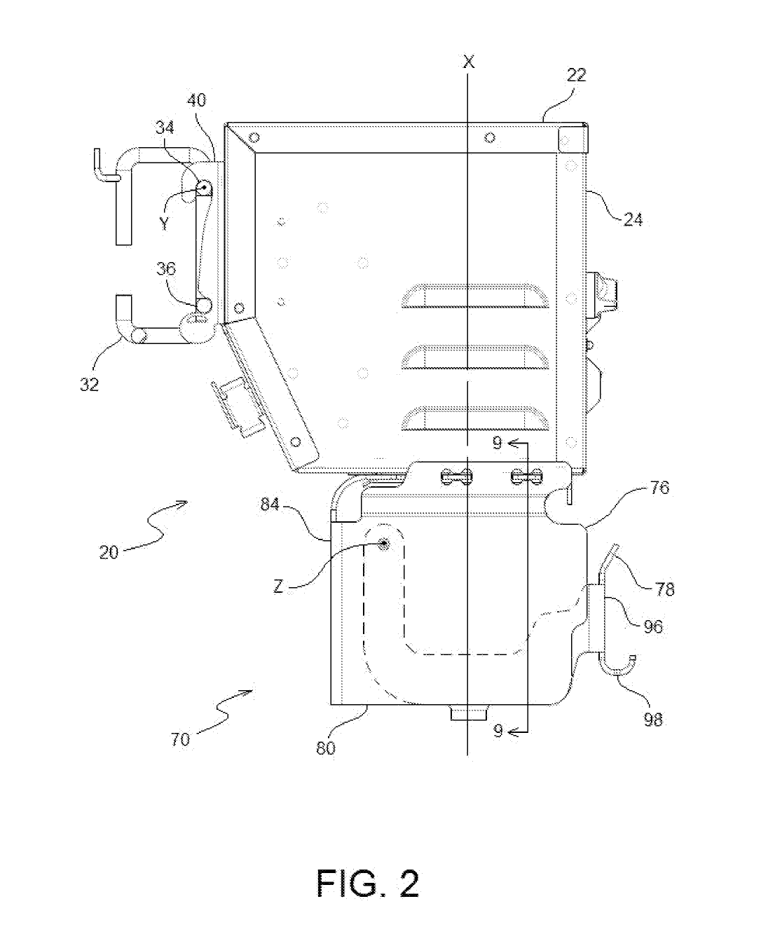

Referring now to FIGS. 1 & 2, an example blending assembly 20 is shown that comprises a blending apparatus 22. The blending apparatus 22 can be a spindle mixer or other blending device and can comprise a housing 24 and an electric motor (not shown) provided within the housing 24. An elongated spindle 26 can be mechanically attached to the motor and can extend downwardly from the motor through a bottom of the housing 24. The motor can be operable to rotate the spindle 26 about a rotational axis X that is substantially vertical. In some embodiments, an agitator can be coupled to the end of the spindle 26 extending out of the housing 24. A container can be placed below the housing 24 around the agitator and the motor can be operated to rotate the spindle 26 and coupled agitator to mix contents within a container.

In order to elevate the housing 24 and spindle 26 such that a container can be provided below for mixing, the blending apparatus 22 can comprise a base and a stand (not shown) that extends upward from the base and supports the housing 24 at a desired elevation. Alternatively, the blending assembly 20 can comprise a rail 32 and the blending apparatus 22 can be coupled to the rail 32 to elevate the blending apparatus 22, as shown in FIGS. 1 & 2.

The rail 32 can comprise an upper rail member 34 and a lower rail member 36. The upper and lower rails members 34, 36 can be cylindrical rods that are spaced apart and arranged substantially parallel to each other. In particular, the upper and lower rails members 34, 36 can be arranged substantially horizontal. However, the upper and lower rails members 34, 36 can take on variety of different configurations and orientations without departing from the scope of the invention.

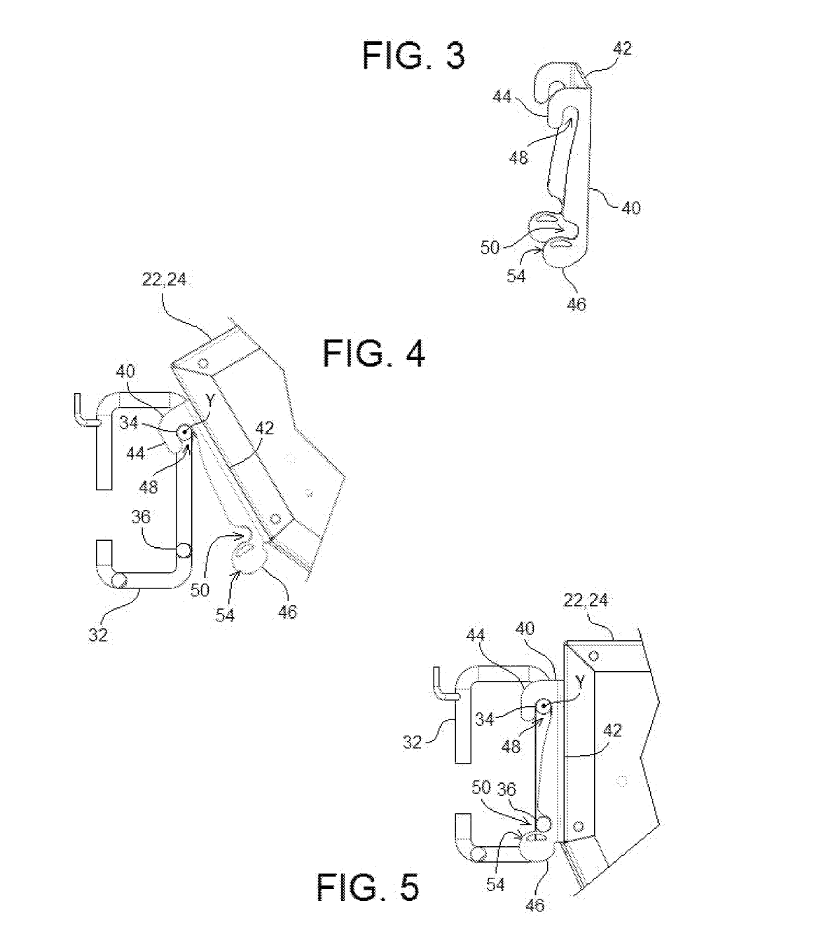

The blending assembly 20 can comprise a mounting bracket 40 for mounting the blending apparatus 22 to the rail 34. As shown in FIGS. 3-5, the mounting bracket 40 can comprise a main body portion 42. The main body portion 42 can be attachable to the blending apparatus 22. For example, the main body portion 42 can be attached to a back of the housing 24 of the blending apparatus 22 using various means such as threads, fasteners, hooks, clips, adhesive, welds, or other means of attaching two objects. The mounting bracket 40 can comprise an upper latching or hook portion 44 and a lower latching portion 46 that both extend from the main body portion 42. The upper latching portion 44 and lower latching portion 46 can respectively define upper and lower receiving recesses 48, 50 for receiving the upper and lower rail members 34, 36. The mounting bracket 40 and attached blending apparatus 22 can be removably mountable to the rail 34 by latching (e.g., hooking) the upper latching portion 44 about the upper rail member 34 at a first position (as shown in FIG. 4) such that the upper rail member 34 is received within the upper receiving recess 48. The main body portion 42 and attached blending apparatus 22 can then be rotated about a longitudinal axis Y of the upper rail member 34 to a second position (as shown in FIG. 5) wherein the lower rail member 36 is received within the lower receiving recess 50 of the lower latching portion 46. To remove the mounting bracket 40 and blending apparatus 22 from the rail 34, the main body portion 42 and attached blending apparatus 22 can be rotated about the longitudinal axis Y back to the first position and the upper latching portion 44 can be unlatched from the upper rail member 34.

In some examples, the lower latching portion 46 can be configured to inhibit movement of the lower rail member 36 into and out of the lower receiving recess 50 as the main body portion 42 is rotated between the first and second positions. For example, in the embodiment shown in FIGS. 3-5, the lower latching portion 46 can comprise a curved surface 54 that engages the lower rail member 36 as the main body portion 42 is rotated between the first and second positions and inhibits (e.g., reduces) movement of the lower rail member 36 into and out of the lower receiving recess 50. The curved surface 54 can be configured such that the curved surface 54 will interfere with the lower rail member 36 as the main body portion 42 is rotated between the first and second positions, thereby inhibiting (e.g., reducing) movement of the lower rail member 36 into and out of the lower receiving recess 50. Thus, the curved surface 54 can help hold the mounting bracket 40 in the mounted, first position. To move the mounting bracket 40 out of the first position, a rotational force can be required to overcome the interference of the curved surface 54 and move the lower rail member 36 past the curved surface 54 out of the lower receiving recess 50.

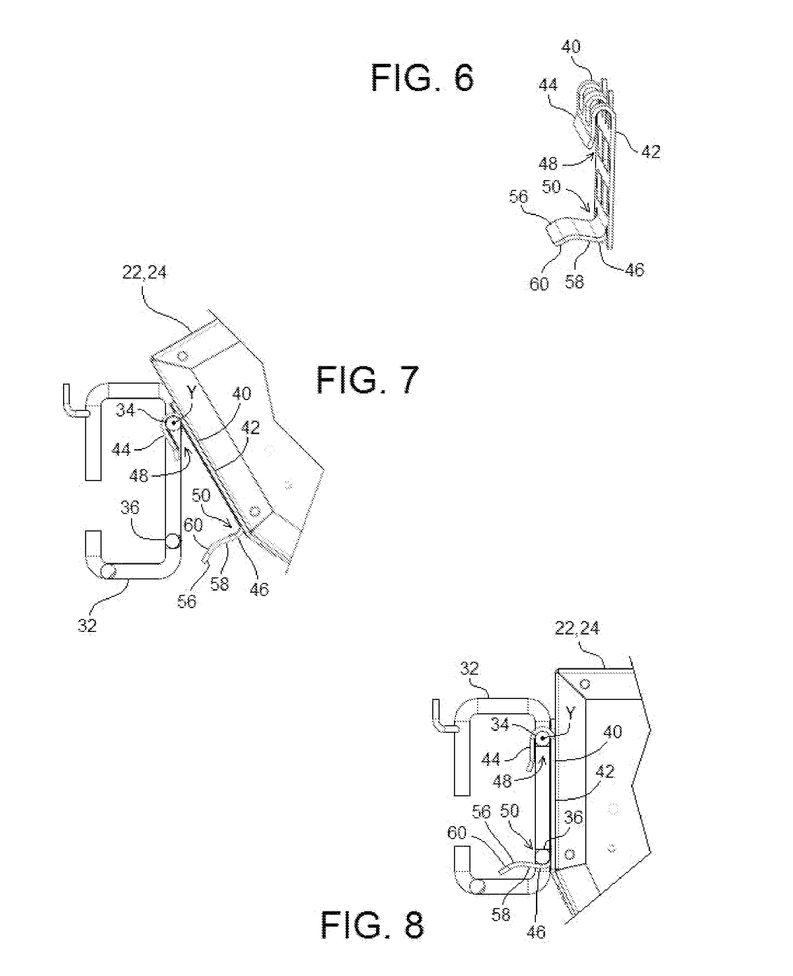

In another embodiment of the mounting bracket 40, the lower latching portion 46 can comprise a lever member 56 that inhibits movement of the lower rail member 36 into and out of the lower receiving recess 50 as the main body portion is rotated between the first and second positions, as shown in FIGS. 6-8. The lever member 56 can comprise a first lever portion 58 that extends from the main body portion 42 in a direction toward the upper latching portion 44 and a second lever portion 60 that extends from the first lever portion 58 in a direction away from the upper latching portion 44. The lever member 56 can be distanced from the upper latching portion 44 such that the lever member 56 will interfere with the lower rail member 36 as the main body portion 42 is rotated between the first position (shown in FIG. 7) and the second position (shown in FIG. 8) and the lower rail member 36 is moved into and out of the lower receiving recess 50. Thus, the lever member 56 can help hold the mounting bracket 40 in the mounted, first position. However, the lever member 56 can be elastically deformable in a direction away from the upper latching portion 44 so that the distance between the lever member 56 and the upper latching portion 44 can be increased, thereby reducing or eliminating any interference between the lever member 56 and the lower rail member 36 as the main body portion 42 is rotated between the first and second positions. Thus, a user can apply force to the lever member 56 to displace the lever member 56 when it is desired to move the mounting bracket 40 from mounted position.

The blending assembly 20 can comprise one or more mounting brackets 40 as described above for mounting the blending apparatus 22 to the rail 34. Moreover, each mounting bracket 40 can comprise multiple upper latching portions 44 and/or lower latching portions 46 or a single upper latching portion 44 and/or lower latching portion 46.

Referring back now to FIGS. 1 & 2, the blending assembly 20 can comprise a splash guard assembly 70 for shielding an operator from splashing that may be generated during operation of the blending apparatus 22. The splash guard assembly 70 can comprise a splash guard mount 74, a splash guard body 76, and a splash shield 78. The splash guard mount 74 can be integral with the housing 24 of the blending apparatus 22 or separately attached to the housing 24 using various means such as threads, fasteners, hooks, clips, adhesive, welds, or other means of attaching two objects. Moreover, as will be discussed in further detail below, the splash guard body 76 can be removably attachable to the splash guard mount 74 and the splash shield 78 can be removably attached to the splash guard body 76.

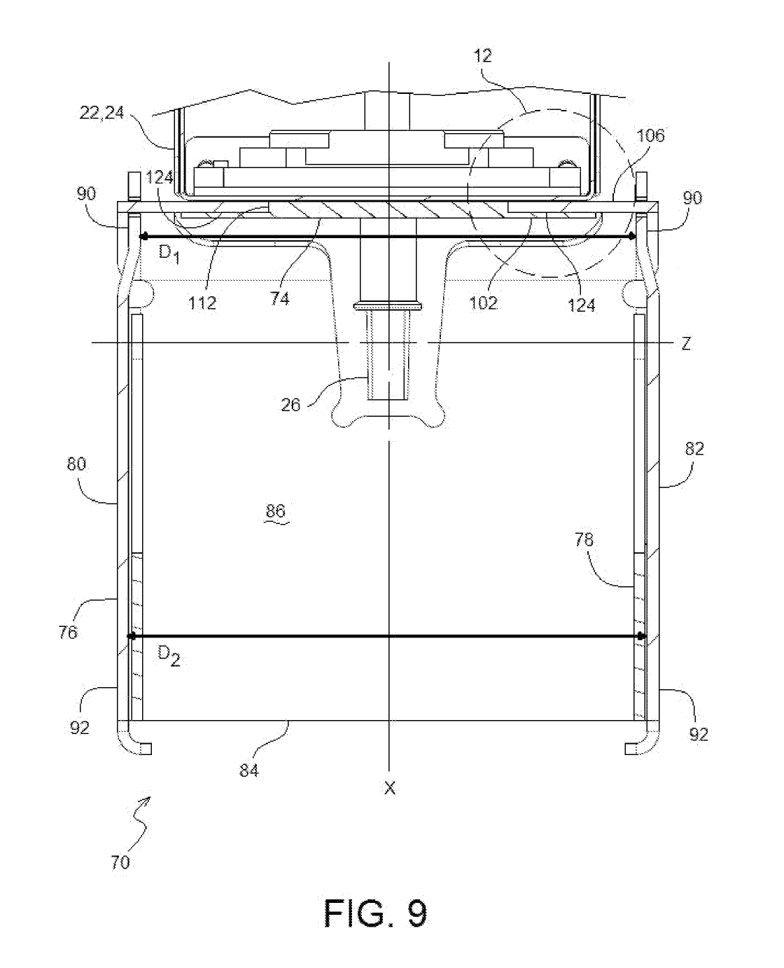

The splash guard body 76 can comprise first and second side walls 80, 82 that are spaced apart and aligned substantially parallel to each other. Moreover, the splash guard body 76 can comprise a back wall 84 that extends between the first and second side walls 80, 82 and is arranged substantially perpendicular to the first and second side walls 80, 82. The back wall 84 and the first and second side walls 80, 82 can all be aligned substantially vertical such that the back wall 84 and the first and second side walls 80, 82 will extend downward from the blending apparatus 22 when the splash guard body 76 is mounted thereto to partially enclose an area 86 surrounding the spindle 26, as shown in FIG. 9. However, the back wall 84 and the first and second side walls 80, 82 can have a variety of different arrangements to partially enclose the area 86 without departing from the scope of the invention.

In some examples, the first and second side walls 80, 82 can have a flared or tapered configuration such that a distance between the first and second side walls 80, 82 varies between lower or upper portions of the first and second side walls. More specifically, as shown in FIG. 9, the first and second side walls 80, 82 can each comprise an upper portion 90 and a lower portion 92. The upper portions 90 of the first and second side walls 80, 82 can be spaced apart a first distance D₁ from each other that is preferably close in size to the width of the spindle mixer housing 24, though other distances are possible. Meanwhile, the lower portions 92 of the first and second side walls 80, 82 can be spaced apart a second distance D₂ from each other, wherein the second distance D₂ is not equal to the first distance D₁. The second distance D₂ can be greater than the first distance D₁ (see FIG. 9) or the second distance D₂ can be smaller than the first distance D₁. The second distance D₂ is preferably determined so that the splash guard body 76 properly accommodates a particular size or type of blending container. For example, the second distance D₂ may be set to provide a small enclosure for small containers or a large enclosure for large containers.

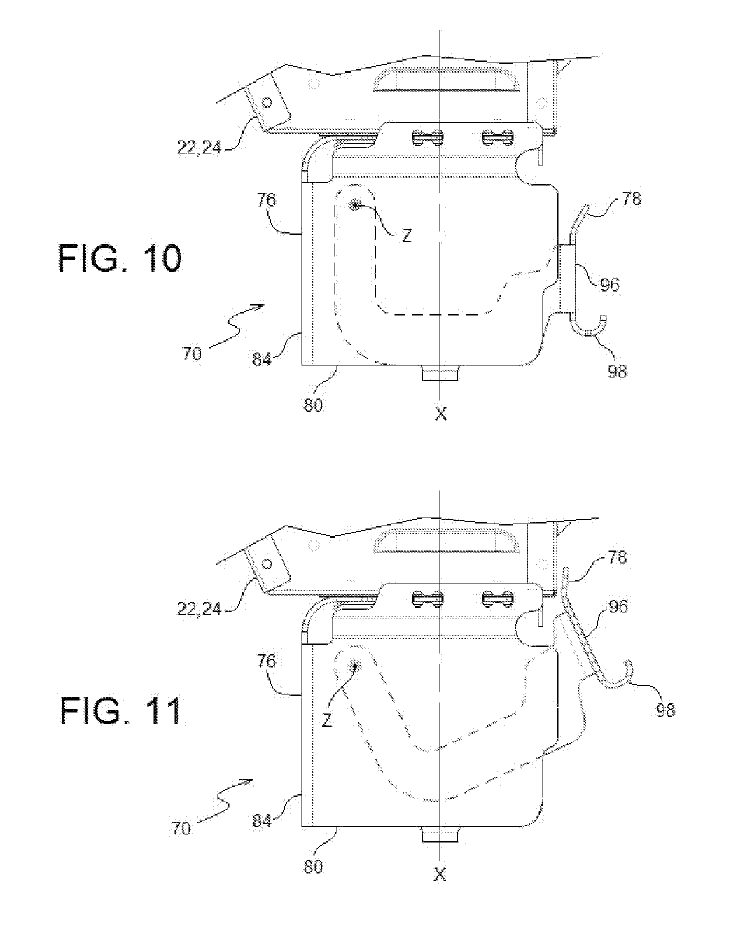

Turning now to FIGS. 10 & 11, the splash shield 78 can be movably coupled the splash guard body 76 such that the splash shield 78 is movable between an open and closed position. For example, the splash shield 78 can be pivotally coupled to the splash guard body 76 such that the splash shield 78 can be pivoted about an axis Z between a closed position (shown in FIG. 10) and an open position (shown in FIG. 11). The axis Z can be substantially horizontal and parallel to the back wall 84. Moreover, the axis Z can be located behind the rotational axis X of the spindle 26. However, other locations and orientations of the axis Z are possible. It is noted that the splash shield 78 may be pivotally or otherwise movably coupled to the splash guard body 76 via other means, such as via a hinge, or the like. As such, the splash shield 78 may be hingedly secured to the splash guard body 76.

The splash shield 78 can comprise a shield panel 96. The shield panel 96 can be configured such that when the splash shield 78 is in the closed position, the shield panel 96 will be arranged substantially perpendicular to the first and second side walls 80, 82 and will partially enclose a front portion of the area 86, thereby shielding an operator from splashing generated within the area 86 that may be projected towards the front of the blending apparatus 22 and toward the user. Meanwhile, when the splash shield 78 is in the open position, access may be provided to the area 86 through the front.

The splash shield 78 can further comprise a lower edge portion 98 that extends from the shield panel 96 and provides a generous bearing surface for an operator's hand or wrist or arm to act upon in order to move the splash shield 78. For example, the lower edge portion 98 can be rounded with a generous radius that provides a smooth and comfortable bearing surface for the user. However, in other embodiments, the lower edge portion 98 may include secondary pieces, overmolded pieces, or soft durometer materials to provide a generous bearing surface.

The splash guard assembly 70 described above, when attached to the blending apparatus 22, can help shield an operator from splashing generated during mixing operations within the area 86 enclosed by the splash guard body 76 and splash shield 78. Moreover, as will now be discussed in further detail, the splash guard body 76 can be removably attachable to the splash guard mount 74 such that the splash guard body 76 can be removed and attached to the splash guard mount 74 without the use of tools (e.g., screw drivers, wrenches, power drills, etc.). This can allow for easy removal and reattachment of the splash guard body 76 during cleaning operations or other operations that require removal or attachment of the splash guard body 76.

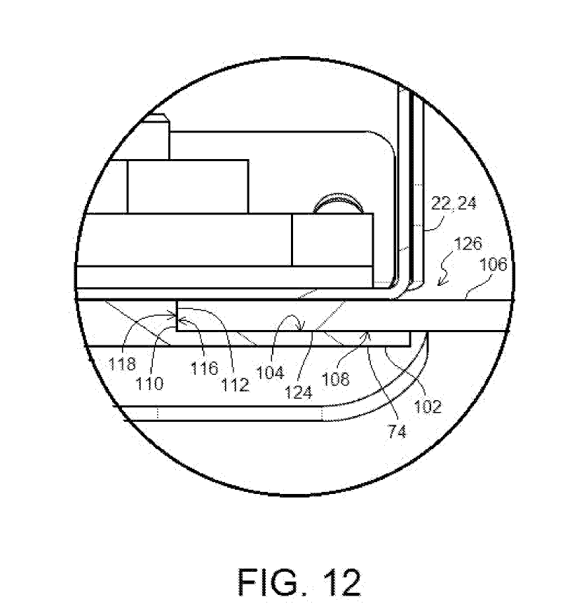

For instance, one example embodiment of the splash guard assembly 70 is shown in FIG. 1 and more closely in FIGS. 9 & 12 wherein the splash guard body 76 is slidably connectible to the splash guard mount 74 to removably attach the splash guard body 76 to the splash guard mount 74 without the use of tools. More specifically shown in FIG. 12, the splash guard mount 74 can comprise a support portion 102 having an upper support surface 104 and the splash guard body 76 can comprise a coupling portion 106 having a lower coupling surface 108 that can be slid over the upper support surface 104 to slidably couple the splash guard body 76 to the splash guard mount 74 when the splash guard mount 74 is attached to the blending apparatus 22. When the splash guard body 76 is slidably coupled as such, the coupling portion 106 of the splash guard body 76 is supported by the upper support surface 104 of the splash guard mount 74, thereby suspending the splash guard body 76 from and coupling the splash guard body 76 to the blending apparatus 22.

The coupling portion 106 can be a portion that extends from one or more of the back wall 84 and first and second side walls 80, 82. In the present embodiment, the coupling portion 106 extends substantially perpendicular from the back wall 84 and the first and second side walls 80, 82. However, the coupling portion 106 can take on a variety of arrangements without departing from the scope of the invention. Moreover, in some examples, the splash guard body 76 can comprise one or more coupling portions 106 that can be slid over one or more corresponding support portions 102 of the splash guard mount 74 to slidably couple the splash guard body 76 to the splash guard mount 74 when the splash guard mount 74 is attached to the blending apparatus 22.

The splash guard body 76 is preferably slidably coupled to the splash guard mount 74 by sliding the coupling portion 106 of the splash guard body 76 across the support portion 102 in a direction toward the rear of the blending apparatus 22 and substantially parallel to the first and second side walls 80, 82. Moreover, splash guard body 76 is preferably slidably coupled to the splash guard mount 74 such that the splash guard body 76 will be aligned with its opening facing the front of the blending apparatus 22. However, other directions for sliding the splash guard body 76 and other alignments of the splash guard body 76 when slidably coupled are possible.

To aid in slidably coupling the splash guard body 76 to the splash guard mount 74 and ensuring that the splash guard body 76 is properly aligned when coupled, the splash guard assembly 70 can further comprise a cutout portion 110 and an insert portion 112 that slidably engages within the cutout portion 110 when the splash guard body is properly aligned and slidably coupled to the splash guard mount. As can be seen in FIG. 1, the splash guard body 76 can comprise the cutout portion 110 and the splash guard mount 74 can comprise the insert portion 112 though in other embodiments, the splash guard mount 74 can comprise the cutout portion 110 and the splash guard body 76 can comprise the insert portion 112. The cutout and insert portions 110, 112 can respectively comprise corresponding first and second mating surfaces 116, 118. The first mating surface 116 of the cutout portion 110 can be configured to mate with the corresponding second mating surface 118 of the insert portion 112 when the splash guard body 76 is properly aligned and slidably coupled to the splash guard mount 74. For example, the first and second mating surfaces 116, 118 of the cutout and insert portions 110, 112 can both be substantially U-shaped. Moreover, the first mating surface 116 of the cutout portion 110 can extend substantially perpendicular from the lower coupling surface 108, and the second mating surface 118 of the insert portion 112 can extend substantially perpendicular from the upper support surface 104 so that the first and second mating surfaces 116, 118 mate with each other when the splash guard body 76 is slidably coupled to the splash guard mount 74. However, other configurations of the first and second mating surfaces 116, 118 are possible without departing from the scope of the invention.

In addition or as an alternative to the cutout and insert portions 110, 112 described above, the splash guard assembly 70 can comprise at least one guide portion 124 and at least one corresponding channel 126 to aid in slidably coupling the splash guard body 76 to the splash guard mount 74 and ensuring that the splash guard body 76 is properly aligned when coupled, as shown in FIG. 12. The splash guard body 76 can be slidably connectible to the splash guard mount 74 by sliding the guide portion 124 through the corresponding channel 126. As shown in FIG. 12, the coupling portion 106 of the splash guard body 76 can comprise the guide portion 124. Moreover, the channel 126 can be defined by the splash guard mount 74 and the blending apparatus 22 when the splash guard mount 74 is mounted to the blending apparatus 22. More specifically, the channel 126 can be defined by the upper support surface 104 and mating surface 118 of the splash guard mount 74 as well as a lower surface of the spindle mixer housing 24. However, the guide portion 124 may be provided by the splash guard mount 74 or other parts of the splash guard body 76 in other examples. Likewise, the channel 126 can be defined by the splash guard body 76 or other parts of the splash guard mount 74.

In some embodiments, the splash guard assembly 70 can comprise at least one recess 130 and at least one corresponding locking projection 132 that engages within the at least one recess 130 when the splash guard body 76 is slidably coupled to the splash guard mount 74. Such engagement of the locking projection 132 within the recess 130 can inhibit movement between the splash guard body 76 and the splash guard mount 74 and increase stability of the coupling between therebetween. For example, as shown in FIG. 1, the insert portion 112 of the splash guard mount 74 can comprise multiple recesses 130 and the coupling portion 106 of the splash guard body 76 can comprise multiple locking projections 132 that correspond to the recesses 130 and will engage within the recesses 130 when the when the splash guard body 76 is slidably coupled to the splash guard mount 74, thereby inhibiting the splash guard body 76 from being decoupled from the splash guard mount 74. However, one or more locking projections 132 may be provided by the splash guard mount 74 or other parts of the splash guard body 76 in other examples. Likewise, the one or more recesses 130 can be provided by the splash guard body 76 or other parts of the splash guard mount 74.

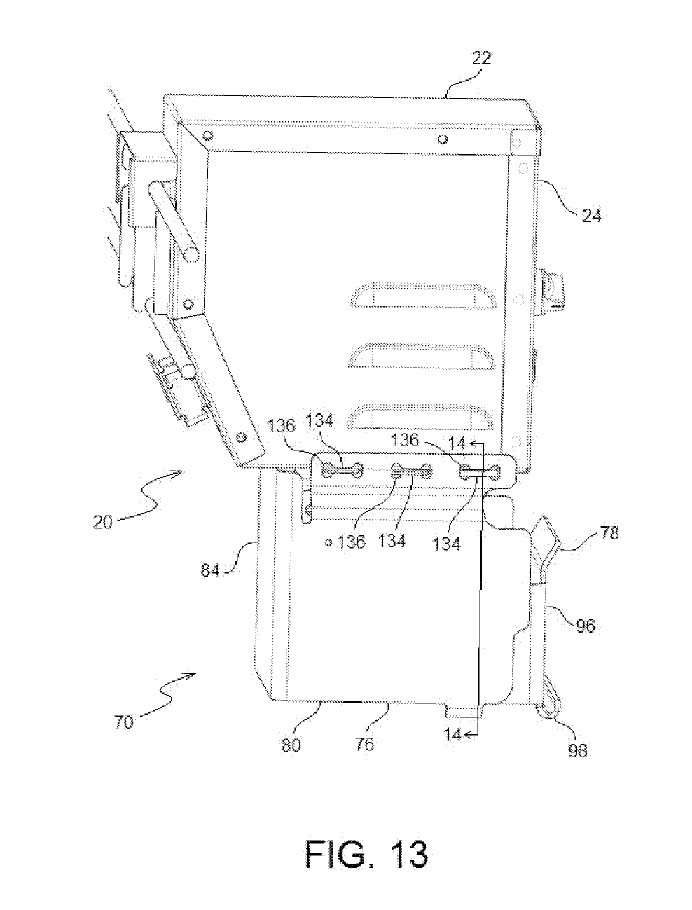

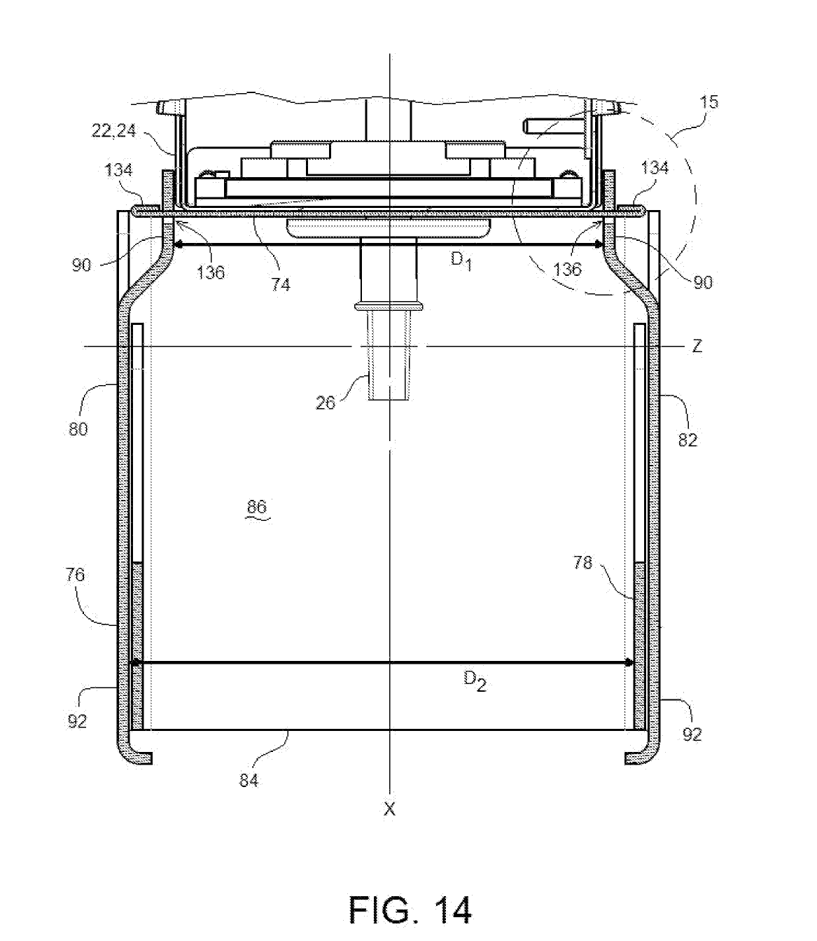

Turning now to FIGS. 13-15, another example embodiment of the splash guard assembly 70 is shown wherein the splash guard body 76 is removably coupleable to the splash guard mount 74 without the use of tools by inserting one or more insert members 134 through one or more corresponding apertures 136. More specifically, the splash guard mount 74 can comprise multiple insert members 134 provided on opposite sides of the splash guard mount 74. Moreover, the splash guard body 76 can comprise multiple apertures 136 that extend through the first and second side walls 80, 82 of the splash guard body 76 and correspond to the multiple insert members 134. The splash guard body 76 can be removably mounted to the splash guard mount 74 by inserting the multiple insert members 134 through the corresponding multiple apertures 136. When the splash guard body 76 is removably coupled as such, the splash guard body 76 will be supported by the insert members 134 of the splash guard mount 74, thereby suspending the splash guard body 76 and coupling the splash guard body 76 to the blending apparatus 22. To remove the splash guard body 76 from the splash guard mount 74, the upper portions 90 of the first and second side walls 80, 82 can be bent slightly outwards to disengage the insert members 134 from the apertures 136.

Although the example embodiment shown in FIGS. 13-15 comprises multiple insert members 134 and apertures 136 provided respectively by the splash guard mount 74 and the splash guard body 76, there may be other embodiments wherein the splash guard body 76 is removably coupleable to the splash guard mount 74 by inserting a single insert member 134 through a single aperture 136. The splash guard assembly 70 can comprise any number of insert members 134 and corresponding apertures 136 without departing from the scope of the invention. Moreover, the one or more insert members 134 and apertures 136 can be provided at different locations and/or by different components. For example, in some embodiments, the side wall 82 of the splash guard body 76 can comprise an insert member 134 corresponding to an aperture 136 provided by the splash guard mount 74, as shown in FIG. 16. The insert members 134 and corresponding apertures 136 can have a variety of different configurations without departing from the scope of the invention.

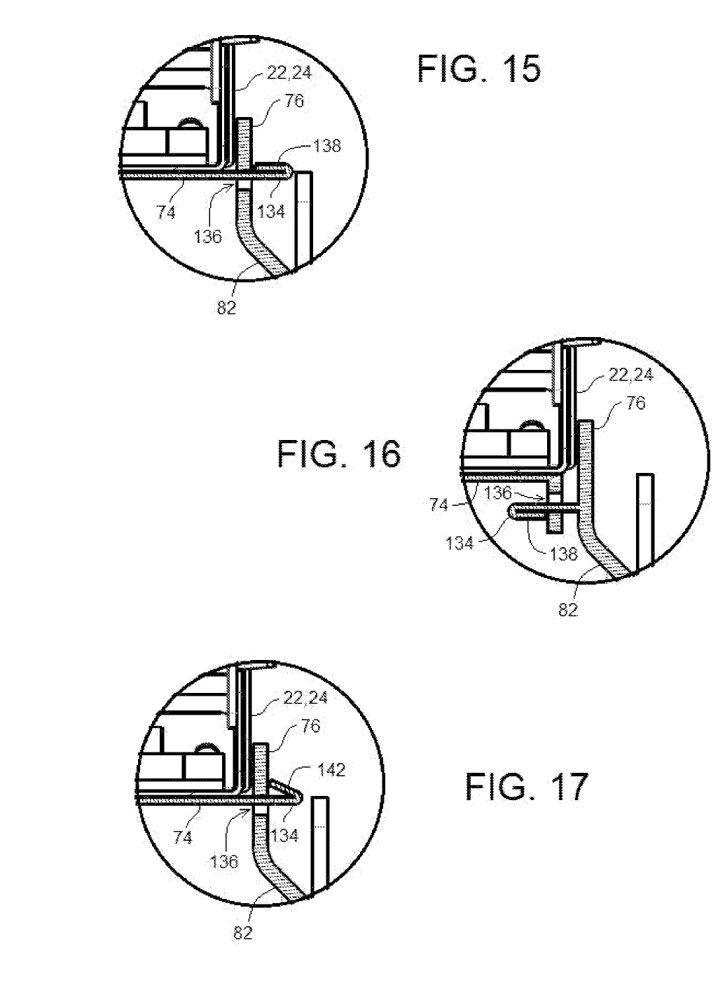

In some examples, in order to inhibit accidental disengagement of the one or more insert members 134 with the one or more corresponding apertures 136, each insert members 134 can comprise an end portion 138 which latches to its corresponding aperture 136 to secure the splash guard body 76 to the splash guard mount 74 and requires the splash guard body 76 to be lifted for the corresponding aperture 136 to clear the end portion 138 and disengage the insert member 134. For example, as shown in FIG. 15, the end portion 138 can be a raised ridge that would require a user to consciously lift the splash guard body 76 to clear the raised ridge and disengage the shown insert member 134 and aperture 136. As another example, as shown in FIG. 16, the end portion 138 can be a lower ridge that would require a user to consciously lift the splash guard body 76 to clear the lower ridge and disengage the shown insert member 134 and aperture 136. It is noted that other end portions may be utilized. For instance, an insert member 134 may comprise a locking member that may be disposed proximal to the end portion 138. The locking member may receive and/or be coupled with an appropriate locking mate. For example, an end member may include an aperture that may be coupled with a pin.

In other examples, in order to inhibit accidental disengagement of the one or more insert members 134 with the one or more corresponding apertures 136, the insert members 134 can additionally or alternatively each comprise a flexible latching member 142 that can be inserted through a corresponding aperture 136 to couple the splash guard body 76 to the splash guard mount 74, as shown in FIG. 17. The flexible latching member 142 can be elastically deformable between an expanded state (as shown in FIG. 17) and a compressed state. Moreover, the flexible latching member 142 can be angled such that as the flexible latching member 142 is inserted through the corresponding aperture 136 to couple the splash guard body 76 to the splash guard mount 74, the flexible latching member 142 will deform to the compressed state to permit further insertion of the flexible latching member 142 through the corresponding aperture 136. However, once the flexible latching member 142 is completely inserted past the corresponding aperture 136, the flexible latching member 142 will return to the expanded state, thereby inhibiting the flexible latching member 142 from being retracted through the corresponding aperture 136. Once it is desired to decouple the splash guard body 76 from the splash guard mount 74, force can be applied to the flexible latching member 142 to deform the flexible latching member 142 to its compressed state, thereby permitting the flexible latching member 142 to be retracted through the corresponding aperture 136.

It will be apparent to those skilled in the art that various modifications and variations can be made to the present disclosure without departing from the spirit and scope of the invention. Thus, it is intended that the present invention cover the modifications and variations of this disclosure provided they come within the scope of the appended claims and their equivalents.

What is claimed is:

1. A splash guard assembly for a blending apparatus comprising:
a splash guard mount that is attachable to the blending apparatus; and
a splash guard body that is removably attachable to the splash guard mount.

2. The splash guard assembly of claim 1, wherein the splash guard body is slidably connectible with the splash guard mount to removably attach the splash guard body to the splash guard mount.

3. The splash guard assembly of claim 2, wherein the splash guard mount comprises a support surface and the splash guard body comprises a coupling surface that slides over the support surface to slidably couple the splash guard body to the splash guard mount.

4. The splash guard assembly of claim 2, wherein the splash guard body is slidably connectible to the splash guard mount by sliding at least one guide portion through at least one channel.

5. The splash guard assembly of claim 4, wherein the splash guard body comprises the at least one guide portion and the at least one channel is defined by the splash guard mount and the blending apparatus when the splash guard mount is attached to the blending apparatus.

6. The splash guard assembly of claim 2, further comprising a cutout portion and an insert portion that slidably engages within the cutout portion when the splash guard body is slidably coupled to the splash guard mount.

7. The splash guard assembly of claim 6, wherein the splash guard body comprises the cutout portion and the splash guard mount comprises the insert portion.

8. The splash guard assembly of claim 6, wherein the cutout portion comprises a first mating surface and the insert portion comprise a second mating surface, wherein the first mating surface mates with the second mating surface when the splash guard body is slidably coupled to the splash guard mount.

9. The splash guard assembly of claim 8, wherein the first mating surface and the second mating surface are both substantially U-shaped.

10. The splash guard assembly of claim 2, further comprising at least one recess and at least one locking projection, wherein the at least one locking projection engages within the at least one recess when the splash guard body is slidably coupled to the splash guard mount.

11. The splash guard assembly of claim 1, wherein the splash guard body is removably attachable to the splash guard mount by inserting an insert member through a corresponding aperture, wherein the splash guard body comprises one of the insert member and the corresponding aperture and the splash guard mount comprises the other of the insert member and the corresponding aperture.

12. The splash guard assembly of claim 11, wherein the insert member comprises an end portion which latches to the aperture to secure the splash guard body to the splash guard mount and requires the splash guard to be lifted for the aperture to disengage the insert member.

13. The splash guard assembly of claim 11, wherein the insert member comprises a flexible latching member that is elastically deformable between an expanded state and a compressed state.

14. The splash guard assembly of claim 1, wherein the splash guard body comprises a first side wall and a second side wall that are substantially parallel and each comprise an upper portion and a lower portion, further wherein the upper portion of the first side wall and the upper portion of the second side wall are spaced a first distance from each other, further wherein the lower portion of the first side wall and the lower portion of the second side wall are spaced a second distance from each other that is different from the first distance.

15. The splash guard assembly of claim 1, further comprising a splash shield coupled to the splash guard body such that the splash shield is movable between an open and closed position.

16. A mounting bracket for mounting a blending apparatus to a rail having an upper rail member and a lower rail member that is spaced from the upper rail member, the mounting bracket comprising:
a main body portion that is attachable to the blending apparatus;
an upper latching portion extending from the main body portion; and
a lower latching portion extending from the main body portion,
wherein the mounting bracket is removably mountable to the rail by latching the upper latching portion to the upper rail member at a first position and rotating the main body portion about an axis of the upper rail member to a second position wherein the lower rail member is received within the lower latching portion.

17. The mounting bracket of claim 16, wherein the lower latching portion comprises a curved surface that engages the lower rail member as the main body portion is rotated between the first and second positions and inhibits movement of the lower rail member.

18. The mounting bracket of claim 16, wherein the lower latching portion comprises a lever member that inhibits movement of the lower rail member as the main body portion is rotated between the first and second positions.

19. The mounting bracket of claim 18, wherein the lever member comprises a first lever portion that extends from the main body portion in a direction toward the upper latching portion and a second lever portion that extends from the first lever portion in a direction away from the upper latching portion.

20. The mounting bracket of claim 18, wherein the lever member is elastically deformable to increase a distance between the lever member and the upper latching portion.
